(19) United States
(12) Patent Application Publication
(10) Pub. No.: US 2010/0115399 A1
(43) Pub. Date: May 6, 2010

(54) METHOD AND APPARATUS FOR GENERATING AN ALBUM OF IMAGES

(75) Inventors: Handoko Kohar, Eindhoven (NL); Jeroen Ronald Johannes Van Der Putten, Eindhoven (NL); Wing Lam Lui, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/531,157

(22) PCT Filed: Mar. 10, 2008
(86) PCT No.: PCT/IB2008/050865

§ 371 Date: Sep. 14, 2009

(30) Foreign Application Priority Data
Mar. 15, 2007 (EP) 07104244.4

(51) Int. Cl. G06F 17/00

(52) U.S. Cl. 715/243

(57) ABSTRACT

An album comprising a plurality of pages, each page containing at least one image, is generated by allowing a user to select a style from a plurality of candidate styles S₁ to S₈, each candidate style comprising a plurality of layout definitions and each layout definition being for a certain amount of images 1 to 6, and allowing the user to place one or more images on a page. A layout for a page is then automatically generated on the basis of said selected style and the amount of images placed on said page.

### FIELD OF THE INVENTION

The present invention relates to a method and apparatus for generating an album of images. In particular it relates to generating page layouts for an album.

### BACKGROUND OF THE INVENTION

Use of digital still and video cameras has rapidly increased. As a result extremely large libraries of storage images are generated. It has become increasingly desirable to have easy and effective systems to organize the vast numbers of images to assist in sharing and displaying images. One such system is to organize the images into electronic albums. An electronic album organizes images and lays out images on a page. As a result electronic albums can cater for the need to share memories with others in an easy way. Further, electronic albums benefit from classical paper based albums (more emotion, more creativity) and digital media (interactivity, versatility).

There are many existing systems in which albums are created by traditional slide shows tools with multiple images on a page having a distinct lay-out on one or more pages.

Some of these systems provide some automation of layout design but these provide limited control with cumbersome user interfaces which are difficult to use.

### SUMMARY OF INVENTION

The present invention seeks to provide a simple and effective user interface which provides immediate results on screen when assigning images to an album page in creating a layout.

According to a first aspect of the present invention, there is provided a method for generating an album, the album comprising a plurality of pages, each page containing at least one image, the method comprising the steps of allowing a user to select a style from a plurality of candidate styles, each candidate style comprising a plurality of layout definitions and each layout definition being for a certain amount of images, allowing the user to place one or more images on a page, and automatically generating a layout for said page on the basis of said selected style and the amount of images placed on said page.

According to a second aspect of the present invention, there is provided an apparatus for generating an album, the album comprising a plurality of pages, each page containing at least one image, the apparatus comprising electronic circuitry operative to allow a user to select a style from a plurality of candidate styles, each candidate style comprising a plurality of layout definitions and each layout definition being for a certain amount of images, allow the user to place one or more images on a page, and automatically generate a layout for said page on the basis of said selected style and the amount of images placed on said page.

The basic idea is that the user makes a selection of images, and selects a style (for example “classical polaroids”) and dynamically the resulting album page is displayed. The candidate styles may be stored and/or displayed in a matrix. In this matrix for each style (horizontal axis) the actual lay-out may be defined for 1 to n images (vertical axis). Each cell may then describe a particular set of data for position of the images, size of the images, cropping of the images, borders, alpha mask (optionally), shadow (optionally), background color/image. Also the orientation of the images can be taken into account so that the images are displayed most optimally within the cells, with as minimal cropping as possible.

Main benefit of the approach is the immediacy of results when assigning images to an album page, while the generated photo album does not have the design flaws of other automatically generated photo albums.

Unlike most album print software, the user does not have to choose upfront for the number of images that he wants to have on a page; instead the user can focus on the content.

### BRIEF DESCRIPTION OF DRAWINGS

For a more complete understanding of the present invention, reference is made to the following description taken in conjunction with the accompanying drawings, in which:

FIG. 1 is a simplified schematic of an example of a look up table used in an embodiment of the present invention; and

FIG. 2 is a simplified diagram of screen illustrating the create mode according to the embodiment of the present invention.

### DETAILED DESCRIPTION OF AN EMBODIMENT OF THE INVENTION

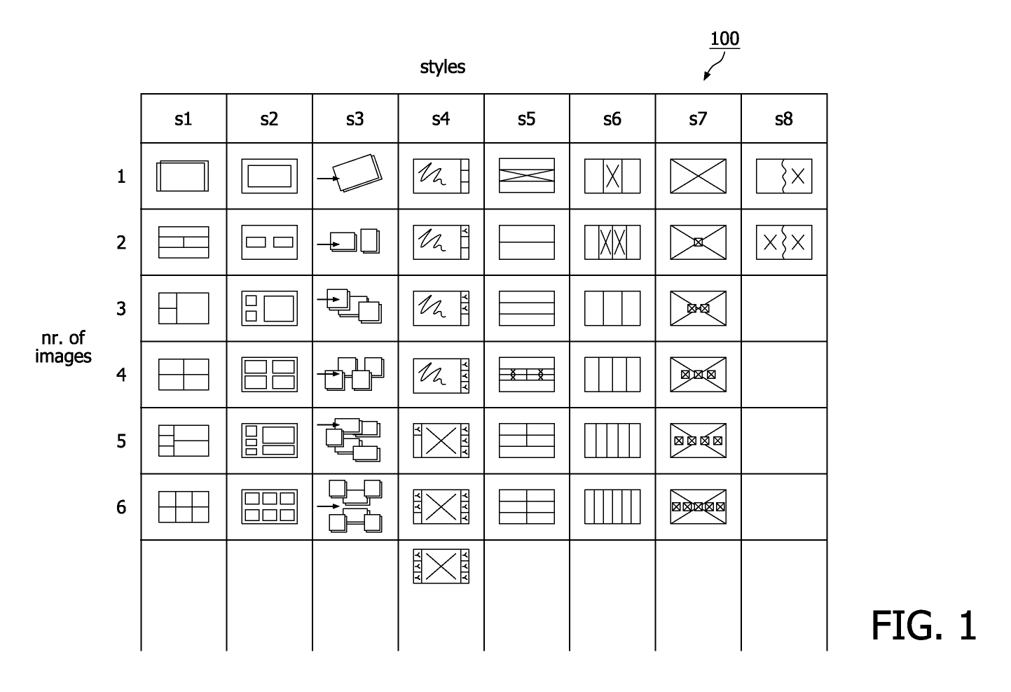

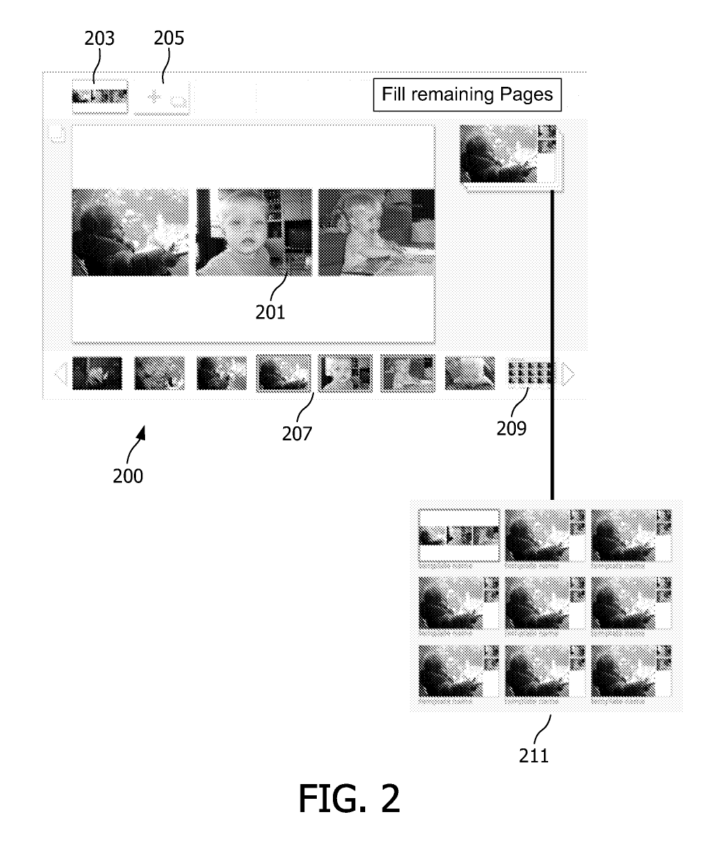

An embodiment of the present invention will now be described with reference to FIGS. 1 and 2.

The user, in creating an album, is allowed to select a style from a plurality of candidate styles. FIG. 1 shows an example of a two-dimensional look-up table 100 having different candidate styles S₁ to S₈ for each column. Each candidate style comprises a plurality of layout definitions (six for most styles). Each layout definition has been associated with a certain amount of images (from one to six images for most styles). In FIG. 1, each cell illustrates the unique layout for a particular style for a particular number of images.

A representation of the look-up table may be displayed on a touch-sensitive screen of, for example, a portable device. Alternatively, this representation may be displayed on a conventional computer screen and selection can be made using a pointer and mouse or the like. Alternatively, this representation may be displayed on a screen activated by a remote control device. The look-up table 100 may be stored locally on a personal computer or other portable device such as a laptop etc or it may be stored centrally at a remote location and accessed via means such as the Internet for example. The representation may show the layout for different amounts of images or may just give a general style impression.

Once a selection is made, the page may be displayed full screen 200 in a create/edit mode as shown in FIG. 2.

The album creation screen 200 comprises a page overview area 203, a canvas area 201, a basket area 207, an edit tools area 209 and a templates area 211. The canvas area 201 is a portion of the screen 200 that displays the images in their page layout. The page overview 203 provides direct access to each page in the album as well as providing the possibility to create a new page. When content is added to a ‘New page’ 205, it is automatically assigned the next available page number and a new ‘New Page’ is created. If more pages are created then can be shown in the page overview area 203, tabs are provided to the left and right of the strip of pages which enable the user to scroll left and right through the strip. Each page view shows a thumbnail of the page represented. The basket area 207 provides access to the images which have been selected for the album. As each image is used in the album, it is removed from the basket area 207. The screen 200 provides access via edit tools area 209 to all the tools necessary to create and edit an album and additional template options are displayed in the template area 211. New pages and page layouts can then be created until all available images have been utilized.

A user is allowed to place one or more images, e.g. from the basket area 207, on an old page or a new page. After the images have been placed, the layout for said page is automatically generated on the basis of said selected style and the amount of images placed on said page. For example, when a page contains two photos and a style S₂ has been chosen, the layout definition from [row S₂, column 2] from look-up table 100 of FIG. 1 is used for that page. When a user now adds one additional photo, a new layout definition, i.e. the layout definition from [row S₂, column 3] from look-up table 100 of FIG. 1, is automatically used for that page.

The apparatus of the invention may be an electronic photo frame or a PC, for example. The electronic circuitry may be a general purpose processor or an application specific processor, e.g. an IC. The apparatus preferable has a touch screen. The apparatus may store images and/or may be operative to retrieve images from an external apparatus, e.g. using the Internet.

Although a preferred embodiment of the present invention has been illustrated in the accompanying drawings and described in the foregoing detailed description, it will be understood that the invention is not limited to the embodiment disclosed, but is capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for generating an album, said album comprising a plurality of pages, each page containing at least one image, the method comprising the steps of:
allowing a user to select a style from a plurality of candidate styles, each candidate style comprising a plurality of layout definitions and each layout definition being for a certain amount of images;
allowing the user to place one or more images on a page; and
automatically generating a layout for said page on the basis of said selected style and the amount of images placed on said page.

2. A method according to claim 1, wherein said plurality of candidate styles is stored in the form of a matrix.

3. A computer program product comprising a plurality of program code portions for carrying out the method according to claim 1.

4. Apparatus for generating an album, said album comprising a plurality of pages, each page containing at least one image, the apparatus comprising electronic circuitry operative to:
allow a user to select a style from a plurality of candidate styles, each candidate style comprising a plurality of layout definitions and each layout definition being for a certain amount of images;
allow the user to place one or more images on a page; and
automatically generate a layout for said page on the basis of said selected style and the amount of images placed on said page.

5. Apparatus according to claim 4, wherein said electronic circuitry is operative to store said plurality of candidate styles in the form of a matrix.

6. Apparatus according to claim 4, wherein the apparatus is an electronic photo frame.
